(19) United States
(12) Patent Application Publication
(10) Pub. No.: US 2017/0076405 A1
(43) Pub. Date: Mar. 16, 2017

(54) GRAPHICAL USER INTERFACE AND SMART CARD READER FOR FACILITATING CROWDSOURCED CREDENTIALING AND ACCREDITATION

(71) Applicant: Netspective Communications LLC, Silver Spring, MD (US)

(72) Inventor: Shahid N. Shah, Silver Spring, MD (US)

(73) Assignee: Netspective Communications LLC, Silver Spring, MD (US)

(21) Appl. No.: 15/362,768

(22) Filed: Nov. 28, 2016

Related U.S. Application Data
(63) Continuation-in-part of application No. 13/865,481, filed on Apr. 18, 2013, now abandoned.

(51) Int. Cl. G06Q 50/00; G06Q 30/00

(52) U.S. Cl. CPC G06Q 50/01; G06Q 30/018

(57) ABSTRACT

A graphical user interface and smart card reader system for facilitating crowdsourced credentialing over a network includes a federated profile manager to maintain profile related information for a plurality of professionals obtained from a plurality of federated sources distributed across the crowdsourced network. The system further includes a profile segmenting engine to segment and classify the profile-related information for each of the professionals into a plurality of federated profiles. The system further includes a certification engine to allow a plurality of crowdsourced respondents to respond to the federated profiles associated with each of the plurality of professionals and credential them. The system is configured as a crowdsourced credentialing-based smart controlled-access system in an embodiment.

### CROSS REFERENCE TO RELATED APPLICATION

This application is a continuation-in-part of U.S. patent application Ser. No. 13/865,481 filed on Apr. 18, 2013, the contents of which, in its entirety, is herein incorporated by reference.

### BACKGROUND

Technical Field

The embodiments herein generally relate to graphical user interfaces (GUIs), and more particularly to GUIs for credentialing, verification and accreditation of profiles through a crowdsourced network of sources, and providing a controlled-access accordingly.

Description of the Related Art

Doctors, physicians, nurses, or other practitioners need to be accredited and credentialed before working at hospitals, practice areas etc. Furthermore, they need to be provided appropriate access according to their accreditations and credentialing. There are existing credentialing services that perform such services. However, these services lack accuracy and reliability in the credentialing of profiles of the practitioners.

There is a need for an improved system and a method that provides a reliable and more accurate credentialing and accreditation service.

### SUMMARY

An embodiment herein provides a graphical user interface (GUI) accessed locally on a computer screen and configured to provide access to a distributed architecture-based system for facilitating crowdsourced credentialing over a crowdsourced communication network, the system comprising a GUI icon stored on a computerized display device; a profile management server, communicatively connected to the crowdsourced communication network and accessible through the GUI icon, comprising a profile information collection module of the distributed architecture based system, comprising a collection processor and a collection memory, configured to collect profile creation information about each of a plurality of professionals distributed over the crowdsourced communication network, wherein the profile creation information is collected from: the plurality of professionals distributed over the crowdsourced communication network; and a plurality of online websites of the plurality of professionals, wherein an online website comprises a social networking profile associated with a social networking platform, and an institutional website, wherein the social networking profile is distinct from the institutional website. A federated profile manager of the distributed architecture based system is communicatively coupled to the profile information collection module and comprising a profile manager processor and a profile manager memory, the federated profile manager is configured to create a plurality of common profiles corresponding to each of the plurality of professionals, using the collected profile creation information by the profile information collection module; a profile segmenting engine of the distributed architecture based system, communicatively coupled to the federated profile manager and accessible through the GUI icon and comprising a profile segmenting processor and a profile segmenting memory, the profile segmenting engine configured to segment each of the plurality of common profiles into a plurality of portions; communicate each of the plurality of portions to the federated profile manager, wherein the federated profile manager is further configured to store the plurality of portions. A profiles database of the distributed architecture based system is accessible through the GUI icon, and is configured to centrally store the plurality of common profiles of the plurality of professionals on a first non-transitory storage media, wherein the profiles database is communicatively coupled to the profile management server, such that the federated profile manager maintains the plurality of common profiles stored in the profiles database. A profile certification server is accessible through the GUI icon and is communicatively connected to the crowdsourced communication network, and comprises a certification engine of the distributed architecture-based system configured to facilitate credentialing of the plurality of common profiles, the certification engine comprises a segment certification engine, comprising a segment certification processor and a segment certification memory, the segment certification engine configured to make available the plurality of portions of each of the plurality of common profiles for verification by a plurality of respondents; receive a plurality of crowdsource responses from the plurality of respondents, using the crowdsourced communication network, wherein each of the plurality of crowdsource responses corresponds to one portion of the plurality of portions of each of the plurality of common profiles; indicates the one portion as correct or as wrong; and includes an attribute indicating a corresponding respondent for the one portion, and a date of the response; credential the one portion, using the crowdsource response, wherein the credentialing the one portion is separate from credentialing any other portion in the plurality of portions; determine a level of accuracy of the credentialing of the one portion using a number of crowdsource responses corresponding to the one portion. A profile certification engine comprises a profile certification processor and a profile certification memory, wherein the profile certification engine is configured to credential the entirety of a common profile that includes the one portion, using a first set of crowdsource responses, wherein all responses in the first set of crowdsource responses correspond to the common profile; determine an index of inconsistencies of the common profile, using a distribution of differences across a plurality of responses corresponding to each portion in the common profile; determine a distribution map indicating extent and coverage of the inconsistencies among the plurality of responses corresponding to each portion in the common profile; determine an overall trust factor of the common profile using the index of inconsistencies and the distribution map; and an auto-validation engine of the distributed architecture-based system accessible through the GUI icon, and comprising an auto-validation processor and an auto-validation memory, communicatively coupled to the profile management server and the profile certification server, and platforms hosting the online websites containing information related to the plurality of professionals, wherein the auto-validation engine is configured to certify the credentialing of the common profiles, already certified by the certification engine, by using the information about the professionals from the online websites, wherein, through a plurality of distributed local machines, one or more of the common profiles and respective credentialing information are accessible by distributed medical entities for learning the overall trust factor about the plurality of common profiles of the plurality of professionals based on a cumulative effect of credentialing and the auto validation of the profile related information, wherein the plurality of local machines comprising at least a first local machine, the first local machine comprising a firewall located in a private network zone; a configurable appliance installed behind the firewall to allow access to a set of computing devices within the network zone of the configurable appliance; a local database communicatively and operatively connected with the configurable appliance for storing, at least in part, the common profiles and respective credentialing information and overall trust factor parsed by the credentialing system; and the display device for presenting an output to a user in response to a user request, the output indicative of the common profiles and respective credentialing information and overall trust factor stored on the local database after processing.

An embodiment herein provides a method for facilitating crowdsourced and multi-level credentialing over a network for use of the multi-level credentialed information by a plurality of medical entities through the crowdsourced network. The method includes receiving profile information from a plurality of crowdsourced professionals. The method further includes segmenting the profile information associated with each of the plurality of professionals into a plurality of federated profiles. The method further includes receiving responses from a plurality of crowdsourced respondents for each of the federated profiles. The responses defining certification of information contained in each of the federated profiles, wherein the certification associated with each of the federated profiles concludes in either verified as correct or verified as wrong. The crowdsourced credentialing facilitates the certification of each of the federated profiles from one or more respondents so as to cumulate an effect of the certification at multiple levels defined by each respondent. The cumulated effect of the certification allows to associate a cumulative segment rating to each of the federated profiles associated with each of the professionals, wherein the responses from each of the professionals associated with each of the federated profiles is associated with an attribute defining the source and the respondent for each of the federated profile during credentialing, and a date of certification. The method further includes auto-validating the responses to further certify the information provided by the respondents for each of the federated profiles through one or more sources of a social networking platform that associates the professionals through a social networking profile. The method further includes either refining the segment rating for each of the federated profiles or associating a separate rating based on a mapping of each of the federated profiles with the social networking profiles. The method further includes facilitating an access by the plurality of medical entities to retrieve the responses identifying credentialing and certification and the refined or associated rating through a web-based portal operating in the crowdsourced network.

An embodiment herein provides a program storage device readable by computer, and comprising a program of instructions executable by the computer to perform a method for facilitating crowdsourced and multi-level credentialing over a network for use of multi-level credentialed information by a plurality of medical entities through the crowdsourced network. The method includes receiving profile information from a plurality of crowdsourced professionals. The method further includes segmenting the profile information associated with each of the plurality of professionals into a plurality of federated profiles. The method further includes receiving responses from a plurality of crowdsourced respondents for each of the federated profiles. The responses defining certification of information contained in each of the federated profiles, wherein the certification associated with each of the federated profiles concludes in either verified as correct or verified as wrong. The crowdsourced credentialing facilitates the certification of each of the federated profiles from one or more respondents so as to cumulate an effect of the certification at multiple levels defined by each respondent. The cumulated effect of the certification allows to associate a cumulative segment rating to each of the federated profiles associated with each of the professionals, wherein the responses from each of the professionals associated with each of the federated profiles is associated with an attribute defining the source and the respondent for each of the federated profile during credentialing, and a date of certification. The method further includes auto-validating the responses to further certify the information provided by the respondents for each of the federated profiles through one or more sources of a social networking platform that associates the professionals through a social networking profile. The method further includes either refining the segment rating for each of the federated profiles or associating a separate rating based on a mapping of each of the federated profiles with the social networking profiles. The method further includes facilitating an access by the plurality of medical entities to retrieve the responses identifying credentialing and certification and the refined or associated rating through a web-based portal operating in the crowdsourced network.

An embodiment herein provides a smart card reader system for accessing a crowdsourced-credentialing-based smart controlled-access system facilitated through crowdsourced credentialing over a crowdsourced communication network, the smart card reader system comprising a profile management server communicatively connected to the crowdsourced communication network. The profile management server may include a profile information collection module comprising a collection processor and a collection memory, configured to collect profile creation information about each of a plurality of professionals distributed over the crowdsourced communication network, wherein the profile creation information is collected from the plurality of professionals distributed over the crowdsourced communication network and a plurality of online websites of the plurality of professionals, wherein an online website includes a social networking profile, and an institutional website such that the social networking profile is distinct from the institutional website. The profile management server includes a federated profile manager communicatively coupled to the profile information collection module. The federated profile manager is configured to create a plurality of common profiles corresponding to each of the plurality of professionals, using the collected profile creation information by the profile information collection module. The system further includes a profile segmenting engine communicatively coupled to the federated profile manager and including a profile segmenting processor and a profile segmenting memory, the profile segmenting engine configured to segment each of the plurality of common profiles into a plurality of portions and communicate each of the plurality of portions to the federated profile manager, wherein the federated profile manager is further configured to store the plurality of portions. The system further includes a profiles database configured to centrally store the plurality of common profiles of the plurality of professionals on a first non-transitory storage media, wherein the profiles database is communicatively coupled to the profile management server, such that the federated profile manager maintains the plurality of common profiles stored in the profiles database. The system further includes a profile certification server, communicatively connected to the crowdsourced communication network. The profile certification server includes a certification engine of the distributed architecture-based system configured to facilitate credentialing of the plurality of common profiles. The certification engine includes a segment certification engine, comprising a segment certification processor and a segment certification memory, wherein the segment certification engine configured is to make available the plurality of portions of each of the plurality of common profiles for verification by a plurality of respondents and receive a plurality of crowdsource responses from the plurality of respondents, using the crowdsourced communication network. Each of the plurality of crowdsource responses corresponds to one portion of the plurality of portions of each of the plurality of common profiles, indicates the one portion as correct or as wrong, includes an attribute indicating a corresponding respondent for the one portion, and a date of the response. The segment certification engine credentials the one portion, using the crowdsource response, wherein the credentialing of the one portion is separate from credentialing any other portion in the plurality of portions. The segment certification engine determines a level of accuracy of the credentialing of the one portion using a number of crowdsource responses corresponding to the one portion. The certification engine further includes a profile certification engine comprising a profile certification processor and a profile certification memory. The profile certification engine is configured to credential the entirety of a common profile that includes the one portion, using a first set of crowdsource responses, wherein all responses in the first set of crowdsource responses correspond to the common profile, determine an index of inconsistencies of the common profile, using a distribution of differences across a plurality of responses corresponding to each portion in the common profile, determine a distribution map indicating extent and coverage of the inconsistencies among the plurality of responses corresponding to each portion in the common profile, determine an overall trust factor of the common profile using the index of inconsistencies and the distribution map. In an example, one or more of the common profiles are accessible by medical entities for learning the overall trust factor about the plurality of common profiles of the plurality of professionals based on credentialing of the profile related information. The system further includes a smart access card system. The smart access card system includes a memory circuit to store predefined rules and the common profiles and respective credentialing information and overall trust factor for processing authentication and providing a controlled access to a smart access card. The smart access card system further includes an integrated circuit (IC) card reader to read information stored on the smart access card, a card receptacle such that the smart access card is configured to be inserted into the card receptacle for reading of the information stored on the smart access card by the IC card reader, a card sensor to detect presence of the smart access card in the receptacle such that the detected information is passed to the IC card reader for further processing, a processing circuit to process the information read by the IC card reader and provide controlled access to the smart access card based on the predefined rules stored in the memory circuit, an access panel to display input and output details regarding a processing activity executed by the processing circuit, and a container to house components of the smart access card system structurally.

### BRIEF DESCRIPTION OF THE DRAWINGS

The features of the disclosed embodiments may become apparent from the following detailed description taken in conjunction with the accompanying drawings showing illustrative embodiments herein, in which:

FIG. 1 illustrates generally, but not by the way of limitation, among other things, an example of an operating environment in which an embodiment may operate;

FIG. 2 illustrates a credentialing system, in accordance with an embodiment herein;

FIG. 3 illustrates a credentialing system, in accordance with an embodiment herein;

FIG. 4 illustrates generally, but not by the way of limitation, among other things, an example of a web-based portal in an operating environment facilitating access to a system of the embodiments herein;

FIG. 5 illustrates a method for credentialing of profiles, in accordance with an embodiment;

FIG. 6 illustrates a credentialing system communicatively coupled to a smart access card system, in accordance with an embodiment herein;

FIG. 7 illustrates a smart access card system and a smart access card, in accordance with an embodiment herein.

FIG. 8 illustrates a credentialing system communicatively and/or operatively connected with a plurality of local machines situated at distributed separate locations, in accordance with an embodiment herein.

FIG. 9 illustrates generally, but not by the way of limitation, a computer system that may be used in accordance with the embodiments herein.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

In the following detailed description, reference is made to the accompanying drawings which form a part hereof, and in which is shown by way of illustration specific embodiments in which the embodiments herein may be practiced. These embodiments, which are also referred to herein as “examples,” are described in sufficient detail to enable those skilled in the art to practice the embodiments herein, and it is to be understood that the embodiments may be combined, or that other embodiments may be utilized and that structural, logical, and electrical changes may be made without departing from the scope of the embodiments herein.

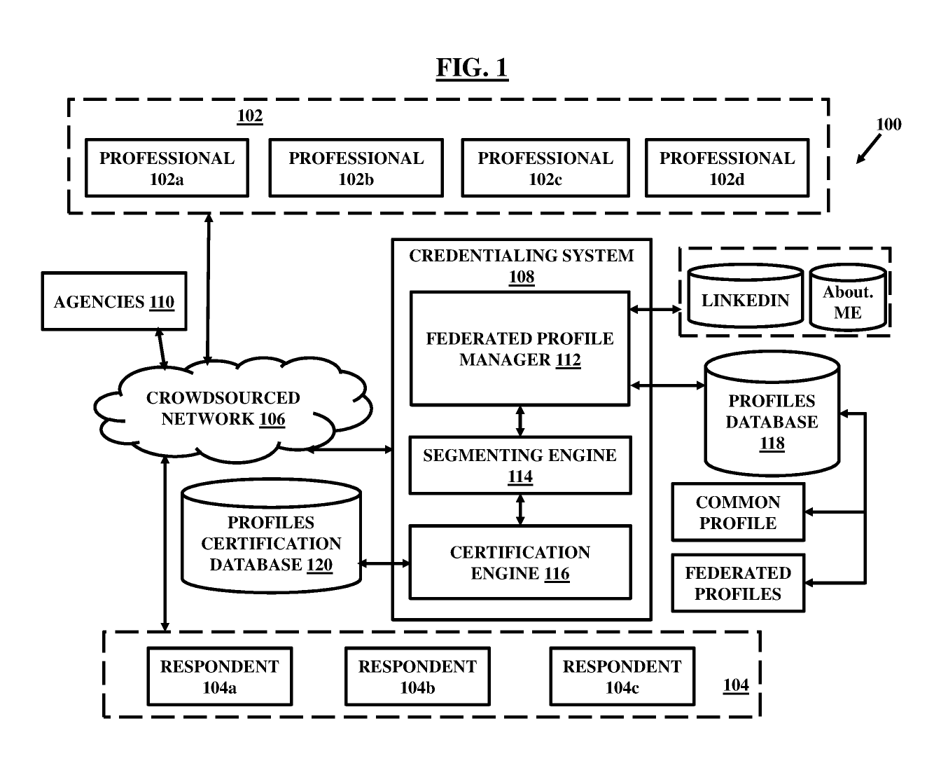

FIG. 1 illustrates generally, but not by the way of limitation, among other things, an exemplary operating environment 100 in which various embodiments may operate. The environment 100 includes a plurality of professionals 102a, 102b, 102c, and 102d (together referred to as 102) and a plurality of respondents 104a, 104b, and 104c (together referred to as 104) connected in a crowdsourced network 106. A credentialing system 108 is connected with the network 106 and is accessible by the professionals 102 and the respondents 104 through the network 106 using for example a web-based interface or portal (not shown in FIG. 1).

The network 106 can employ a wireline or a wired communication channel or both. The wireless communications network may include for example, but not limited to, a digital cellular network, such as Global System for Mobile Telecommunications (GSM) network, Personal Communication System (PCS) network, or any other wireless communications network. The wire line communications network may include for example, but not limited to, a Public Switched Telephone Network (PSTN), proprietary local and long distance communications network, or any other wire line communications network. In addition, the network 106 may include for example, digital data networks, such as one or more local area networks (LANS), one or more wide area networks (WANS), or both LANS and WANS to allow interaction with the system 108. One or more networks may be included in the crowdsourced network 106 and may include both public networks such as the Internet, and private networks and may utilize any networking technology and protocol, such as Ethernet, Token Ring, Transmission Control Protocol/Internet Protocol (TCP/IP), or the like to allow interaction with the system 108.

The professionals 102 can include one or more of a physician, doctor, surgeon, healthcare expert, any other healthcare professional, or any other professional or expert. The respondents 104 may include one or more of a physician, doctor, surgeon, healthcare expert, any other healthcare professional or healthcare organization such as a hospital, or any other professional or expert or any other person who may be interested in credentialing or accreditation process of the professionals 102 or may be any person related to the professionals 102 and may provide a trusted response or comment on information about the professionals 102 such as qualifications, work history and the like. A plurality of healthcare related or other agencies 110 such as hospitals, nursing centers, research institutes, and others or hiring agencies or placement agencies may also access the system 108 to receive credentialing or verification services provided by the system 108 for the plurality of professionals 102. In such embodiments, the system 108 may provide the services to such agencies 110 based on credentialing of the information of the professionals 102 obtained by the respondents 104.

The professionals 102, and respondents 104 and the agencies 110 may be connected with, for example, any type of electronic data processing system or communication device or a client device connected to the communications network. Examples of such an electronic data processing system or client device may include personal computer systems, such as desktop or laptop computers, workstation computer systems, server computer systems, networks of computer systems, personal digital assistants (PDAs), wireless communications devices, portable devices, or any other electronic data processing system. The client devices or data processing systems can include hardware/software computing devices capable of computational tasks associated with profile creation, modification, verification, and presentation and the like as will be discussed later. These tasks can be performed through stand alone application, via Web browser graphical user interface (GUI), or via a Rich Internet Interface (RII). An embodiment herein may be implemented as computer software incorporated as part of an online social networking system. The system 108 can operate with the client device using a Windows, Macintosh, UNIX, Linux or other operating system equipped with a Web browser application, or other Web-enabled device capable of connecting to the crowdsourced network 106.

The credentialing system 108 provides a technical capability and a federation model such that profiles of the professionals 102 may be created including details about the professionals 102 and stored in the system 108. The details may include demographic information, personal information, educational background, work history or any other similar information. These profiles can be shared with the plurality of respondents 104, professionals 102 and agencies 110 based on set standards and preferences and rules to implement a federated exchange capability wherein distinct portions of the profiles can be credentialed or accredited or verified and shared or exchanged with the professionals 102, respondents 104 or agencies 110 in a federated manner. The system 108 further provides a credentialing and verification and accreditation capability such that profiles of each of the professionals 102 may be credentialed or verified or accredited by any other professional or the respondents 104 for the use of the credentialed profiles by other professionals 102 or the agencies 110 such that the entire credentialed information or profiles available and credentialed through federated sources is accessible at a single location from the system 108. In some embodiments, the system 108 further provides a capability to create a federated model of the profiles such that the federated segments or portions or profiles, as will be discussed later in detail, may be verified or credentialed distinctly by distinct federated professionals 102 or respondents 104 in the crowdsourced network 106 such that the crowdsourcing increases the level of trust and authenticity and reliability of the credentialing and credentialed information due to cumulative effect of several federated verifications by the crowdsourced professionals or respondents 104 for the same segments of the profiles.

The credentialing system 108 as shown includes a federated profile manager 112, a segmenting engine 114, and a certification engine 116 discussed below in detail.

The federated profile manager 112 is configured to receive information for profile creation from the plurality of professionals 102. The federated profile manager 112 is responsible for maintaining the information thus received from the professionals 102 and modify it as per updates from the professionals 102. The federated profile manager 112 is configured to be linked to several sources of information that have professionals' presence such as for example their social networks including social networking websites, their educational institutions, work environments and the like. The federated profile manager 112 collects information from a plurality of sources for each of the professionals 102 and collates the records and information in the form of a single common profile of each of the professionals 102 that are associated with and communicate with the system 108. The profile manager 112, for example may collect information from federated sources such as Linkedin, Myspace, About.Me, education institutions, workstations, and the like. The common profile maintained by the system 108 may be viewable by the professionals 102, respondents 104, agencies 110 or any other persons or entities associated with or subscribed to the system 108. In some embodiments, the federated profile manager 112 may automatically retrieve the profile information from the social networks. In other embodiments, the federated profile manager 112 may maintain information that is submitted by the professionals 102 voluntarily

The federated profile manager 112 may allow the professionals 102 to maintain their profiles in the system 108 and protect the information in their profiles and their attention from inappropriate access, and makes their personal profiles connectable. The system 108 may further enable the profiles and information therein as searchable by the professionals 102 and the respondents 104 and the agencies 110. In doing so, the professionals 102 may use a web-based interface to access the user interface or portal of the system 108. The professionals 102 can then create their profiles and update profile information using the user interface after an initial registration process. To register, the professionals 102 may complete a registration page and enter a valid email address as a unique identifier, and a private password. The professionals 102 may then set up their profiles and enter the information. The profile describes the user's background, experience, current and prior interests, capabilities, positions and tiles, skills, values, projects, goals, employing organizations, working stations etc. The professionals 102 can add contacts by entering contact and relationship information, and profile information for the contact, or a link to the contact's own profile on the system 108. The contact information may also be automatically uploaded or extracted from other sources such as an electronic address book, and authorized by the professionals 102 for use in the system 108. The professionals 102 may not want their address book integrated in the system 108. In this case, the professionals' address book would be uploaded, but not integrated into the system 108 and possibly hidden from others. The profiles and contact information may be stored in either a central database or in distributed databases. For example, the system 108 may include or be coupled to a profiles database 118 that may store the information pertinent to the profiles of the professionals 102.

In some embodiments, once a professional 102a joins the network 106 and subscribes with the system 108, the information included in the profiles is ready for credentialing, verification, accreditation, or any other such purpose. The entire profiles can thus be credentialed or verified by the system 108 from the plurality of crowdsourced respondents 104 or other professionals such that the crowdsourced professionals 102 or respondents 104 can verify the profiles and credential them. The credentialing may also determine the profiles as accurate or inaccurate, trustable or non-trustable, authentic or unauthentic, fraud or genuine etc.

In other embodiments, once the plurality of professionals 102 joins the network 106, the profiles are segmented into distinct portions or segments referred to as federated profiles by the segmenting engine 114. The segmenting engine 114 is configured to receive the common profiles from the profile manager 112 and segment them into the federated portions or segments or profiles. For example, a common profile P of the professional 102a may include the following details:

Name: Amir A.

Age: 38 years

Sex: Male

Location: Texas, US

Education: B.S in Computer Science from Purdue University (1995)
M.S. in Computer Science from Purdue University (1997)
M.B.A. in Strategic Management (2005) from Kellogg School of Management

PhD, Competitive Strategies (2011) from Kellogg School of Management Certifications and Awards:
Certification by Microsoft
Certification of Proficiency in Networking Technologies
Best Student award in 1994 by Purdue University

Work Experience:
ABC: 1997-2003
SDF: 2003-2005
XCV: 2011-now

For the purpose of simplicity of description, only some specific details are included as an example in the above profile, however several other details may also be included without limitations. The segmenting engine may be configured to segment the profile into distinct federated profiles. For example, in some embodiments, the above common profile may be segmented by the segmenting engine into several federated profiles as below:
Segment 1: First Name—Amir
Segment 2: Lat Name—A.
Segment 3: Middle Name—Null
Segment 4: Sex—Male
Segment 5: Location (Area)—Texas
Segment 6: Location (Country)—US
Segment 7: Education—B.S.
Segment 8: B.S. in year—1995
Segment 9: Education—M.S.
Segment 10: M.S. in year—1997
Segment 11: B.S. from University/Institute—Purdue University
Segment 12: M.S. from University/Institute—Purdue University
Segment 13: Education—M.B.A
Segment 14: MBA from university/institute—Kellogg School of Management
Segment 15: MBA in year—2005
Segment 16: MBA specialization—Strategic Management
Segment 17: Education—PhD
Segment 18: PhD from University/Institute—Kellogg School of Management
Segment 19: PhD in year—2011
Segment 20: PhD work—Competitive Strategies
Segment 21: Certification—by Microsoft
Segment 22: Certification of proficiency
Segment 23: Certificate of Proficiency in stream—Networking Technologies
Segment 24: Award: Best Student
Segment 25: Award of Best Student received in year—1994
Segment 26: Awarded by—Purdue University
Segment 27: Work Experience—ABC
Segment 28: ABC tenure begins in—1997
Segment 29: ABC tenure ends in—2003
Segment 30: Work Experience—SDF
Segment 31: SDF tenure begins in—2003
Segment 32: SDF tenure ends in—2005
Segment 33: Work Experience—XCV
Segment 34: XCV tenure begins in—2011
Segment 35: XCV tenure ends in—continuing now

As discussed above, a single common profile is segmented by the segmenting engine 114 in thirty-five discrete federated profiles that are distinct in one or the other ways. In accordance with various embodiments, the segmenting engine 114 can be configured to segment a common profile in as many discrete federated profiles as possible. Therefore, the entire information contained in a common profile is segmented into several discrete federated profiles. For example, the above discussed common profile is converted into thirty-five such federated profiles. Upon segmenting, the federated profiles may be communicated to the federated profile manager 112. Thus, the federated profile manager 112 stores common profiles as well as federated profiles associated with the professionals 102 in the profiles database.

The segmenting engine 114 may include hardware and software components capable of computational tasks associated with segmenting of the common profiles into the federated profiles. Once segmented by the segmenting engine 114, the federated profile manager 112 may further classify the federated profiles or segments into groups of federated profiles for the same professionals 102 so that the groups may include similar federated profiles based on certain parameters. For example, the work experience related federated profiles 27, 30, and 33 that define different companies where a professional was employed and is employed may be grouped together do define another type of profile referred to herein as a sub-profile. Similarly, various other groups may be formed to create various other sub-profiles based on several possible permutations and combinations of the federated profiles or segments or profile portions. The system 108 thus can facilitate maintaining of the common profiles, sub-profiles and the federated profiles for the same professionals thus providing a three level profile management facility. It must be appreciated that this document uses the term portion, segment and federated profile interchangeably without limitations.

The credentialing system 108 further includes the certification engine 116 coupled to the segmentation engine 114 and the federated profile manager 112. The certification engine 116 is configured to allow the plurality of crowdsourced respondents 104 to respond to the segmented and classified profiles associated with the plurality of professionals 102 and credential them. The credentialing of each of the segmented portions or federated profiles associated with a professional 102a of the plurality of professionals 102 contributes to credentialing of the entire profile of the professional 102a upon collation of the credentialed portions. For example, the exemplary profile as discussed above includes thirty-five segments. The credentialing of each of the segments influences overall credentialing of the entire common profile. Therefore, if all the thirty-five segments are credentialed and verified as correct by one or more respondents 104, a trust may be associated about the profile information and the information may be considered as true or authentic. As more and more persons or respondents from the plurality of crowdsourced respondents 104 verify the information in the federated profiles, the trust associated with the respective segments increases. Therefore, the crowdsourcing may facilitate in credentialing more accurately and with a higher reliability of the federated profiles than that credentialed from only a few sources. Further, the overall accuracy of the common profile may be determined based on a cumulative effect of accuracy of each of the federated profiles. For example, if the first ten of the segments from the above common profile are verified and the remaining twenty-five segments are not verified due to no response from the respondents 104, this may not yield an overall high accuracy of the common profile and may still require credentialing and verification of the remaining segments but may be considered as acceptable to a certain extent. On the contrary, if the remaining twenty-five segments are rejected and verified as wrong information by the respondents 104, the overall common profile may be considered as inaccurate. Further, since the discrete federated profiles associated with a professional 102a are credentialed from the plurality of crowdsourced respondents 104, there may be a high level of accuracy in the credentialing and the credentialing may be considered as highly authentic and reliable.

The certification engine 116 is adapted certify the stored federated profiles relating to the professionals 102 such as physicians (and any other related health care or other professionals) who must have their credentials verified for use by the agencies 110 or for use in for example by the professionals 102 themselves during filling and submission of forms to various companies for such as hiring purposes or other purposes. The credentialing information related to a particular professional 102a desiring to use the embodiments herein is initially input in the form of a common profile and them segmented and credentialed separately for each of the federated profiles through the crowdsourced network of the plurality of respondents 104 or professionals 102. Therefore, the credentialing information when credentialed for each of the federated profiles is more accurate and valid and acceptable by the agencies 110 than the common profile verified in entirety where special attention may not be paid to every record of the common profile. Secondly, the acceptance of credentialing information by the agencies 110 is much higher through crowdsourcing than for a single verification by a single source. Therefore, according to some embodiments herein, number of sources credentialing a particular federated profile may be associated with each of the segments to indicate a level of accuracy of the credentialing information. For example, if a federated profile is credentialed and verified by eighteen sources in the network, the agency may consider it highly acceptable. Also, the relevant information about credentialing such as who credentialed, when credentialed may also be associated with each credentialing of each of the segments so that an authenticity may be judged by associating an overall impact of the federated profiles' credentialing, number of times credentialed, and trust factor about the source who verified and relevance about the time when verified. Therefore, in such embodiments, a multi-scaled and cumulative score may be determined and multi-scaled and cumulative credentialing may be done based on the multi-scaled cumulative score determined. Further, since a single federated profile may be verified by the plurality of crowdsourced respondents, therefore the system 108 may determine an extent of inconsistency between several credentialing by several different respondents 104 for the same federated profile. In this manner, the system 108 may be configured to determine an index of inconsistency depending of distribution of differences across several credentialing by the several respondents 104. The system 108 may be configured to generate a map indicating extent and coverage of inconsistencies among the several responses and credentialing for the same federated profiles. The map together with the inconsistency index may facilitate in determination of a level of trust in the overall credentialing of the same federated profile. This process may be repeated for each of the federated profiles for a common profile of a professional such as 102a and thus may determine an overall index of inconsistency and overall distribution map and overall trust factor for the common profile.

In some embodiments, the agencies 110 may use the credentialing information, index of inconsistency, and distribution map as obtained from the system 108. The credentialing information may include information such as who verified or credentialed, when verified, how many times verified, how many different and unique verifications, trust factor associated with each verification based on such as a respondent's relationship with a professional such as 102a or any other factor, and other similar information. In some embodiments, the credentialing information may be used by the professionals 102 themselves so that they can use the credentialing information and submit it along with various application forms to companies, hiring agencies, firms, healthcare centers, hospitals or any other agency. Various types of information such as demographic, personal work history, educational information, affiliation with hospitals or institutes etc. can be credentialed. The credentialed information may include such as physician's name, address, practice specialties, appointment status, hospital associations, credentials (including educational background, internships, and residency programs), state licensing information, malpractice liability insurance information, and personal and professional references. This entire information may be stored in the profiles database maintained by the federated profile manager 112.

In some embodiments, the certification engine 116 may be coupled to or may include a profiles certification database 120. The profiles certification database 120 may include the credentialing information as discussed above. In some embodiments, the profiles certification database 120 may be included within the profiles database 118 only, and thus a single database may include memory spaces for storing the profiles information and the certification or credentialing information.

In some embodiments, in creating the common profile and uploading profile information in the database, a separate application form may be completed for each physician or health care professional or any other professional participating in and using the benefits of the system 108. The information in the application form may be preferably provided to the profiles database 118, which may store professionals' profile information using the system 108. The information may be stored as a series of logically organized professionals' profiles and may be extracted as necessary during segmentation by the segmenting engine 114. In some embodiments, the process of segmenting may be initiated by the segmenting engine 114 automatically as and when new information is added or updated. In case the past information is modified, the segmentation task is performed again to update the federated profiles and perform credentialing of the updated federated profiles once again. In such cases, only relevant credentialing may be needed to be revised depending on the updates instead of rejecting the entire past federated profiles and credentialing information associated with them.

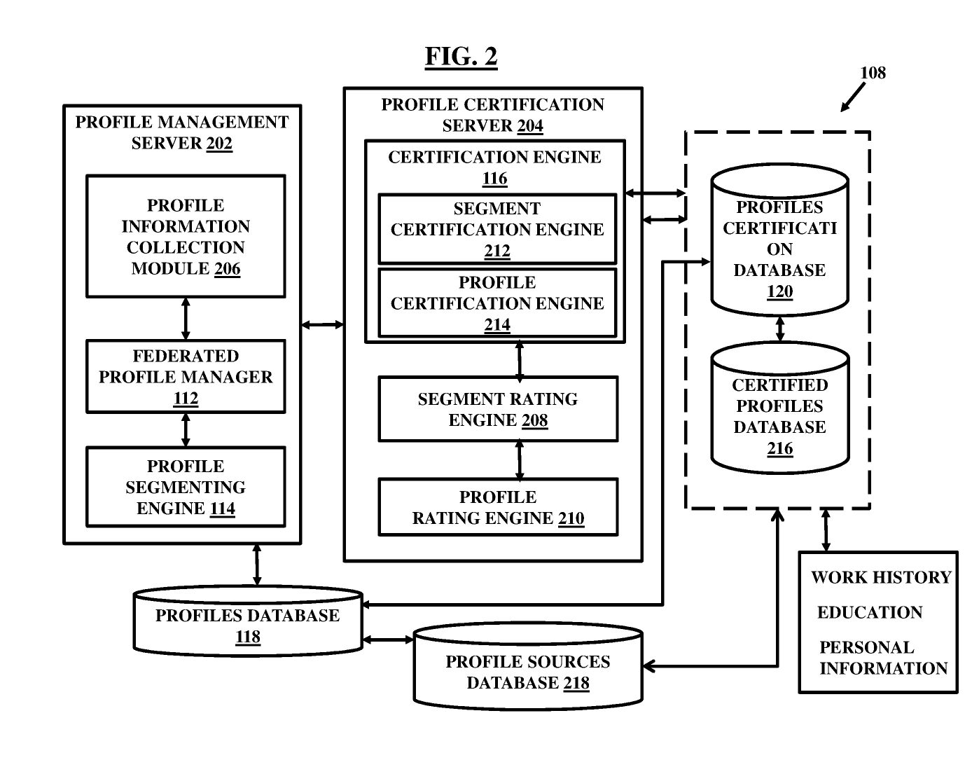

FIG. 2, with reference to FIG. 1, illustrates the credentialing system 108 in accordance with an embodiment. As shown, the system 108 may include a profile management server 202 and a profile certification server 204. The profile management server 202 includes a profile information collection module 206, the federated profile manager 112, and the profile segmenting engine 114.

The profile information collection module 206 may be configured to generate information about the plurality of professionals 102. In some embodiments, the profile information collection module 206 can be disposed separately from the federated profile manager 112; while in other embodiments it can be included in or coupled to the federated profile manager 112. The profile information pertaining to profiles of the plurality of professionals 102 can be generated by distributing application forms through a graphical user interface accessible by the professionals 102 such that the professionals 102 can fill the forms and submit with the system 108. The information can be transformed in the form of profiles by the federated profile manager 112. The segmenting engine 114 may then use the profiles information and perform the task of segmenting of the common profiles into the federated profiles associated with each of the professionals 102.

The profile certification server 204 may be communicatively coupled to or included in the profile management server 202. The profile certification server 204 may include the certification engine 116, a segment rating engine 208, and a profile rating engine 210. The certification engine 116 may further include a segment certification engine 212 and a profile certification engine 214.

The segment certification engine 212 may be configured to facilitate credentialing or certification of the federated profiles associated with the common profiles associated with each of the professionals 102. The segment certification engine 212 is configured to allow the plurality of crowdsourced respondents 104 (or the professionals 102) to respond to the federated profiles associated with the common profiles of the plurality of professionals 102 and credential them. The credentialing of each of the federated profiles associated with the common profiles of each of the professionals 102 contributes to credentialing of the entire common profile of the professionals 102 upon collation of the credentialed federated profiles. As more and more persons or respondents from the plurality of crowdsourced respondents 104 verify the information in the federated profiles, the trust associated with credentialing of the respective federated profiles increases. Therefore, the crowdsourcing may allow credentialing of the federated profiles to a higher degree of accuracy and reliability. Since the discrete federated profiles associated with a professional 102 are credentialed from the plurality of crowdsourced respondents 104, the credentialing defines a high level of accuracy and may be considered as highly authentic and reliable and acceptable by third parties or agencies 110.

The segment certification engine 212 is adapted to certify the stored federated profiles relating to the professionals 102 such as physicians (and any other related health care or other professionals) who must have their credentials verified for use by the agencies 110 or for use in for example by the professionals 102 themselves during filling and submission of forms to various companies for such as hiring purposes or other purposes. According to some embodiments herein, number of sources credentialing a particular federated profile may be associated with each of the segments to indicate a level of accuracy of the credentialing information. Also, the relevant information about credentialing such as who credentialed, when credentialed may also be associated with each credentialing of each of the federated profiles so that an authenticity may be judged by associating an overall impact of the federated profiles' credentialing, number of times credentialed, and trust factor about the source who verified and relevance about the source and time when verified. Therefore, in such embodiments, a multi-scaled and cumulative score may be determined and multi-scaled and cumulative credentialing may be done based on the multi-scaled cumulative score determined.

The information pertaining to credentialing of the individual federated profiles of a particular common profile associated with a professional such as 102a may influence an overall credentialing of the common profile. For example, the individual credentialing of the federated segments may contribute to the overall common profile credentialing such that the credentialing of the overall common profile may depend on each of the federated profiles' credentialing with a weightage attached to each credentialing of the federated profiles. The collated contribution considering weightage effect of each credentialing finally decides credentialing of the overall common profile. The task of credentialing the overall common profile associated with a professional such as 102a may be performed by the profile certification engine 214. For example, the profile certification engine 214 may facilitate credentialing of the profile in entirety based on the collated effect of credentialing of the federated profiles associated with the common profile of a professional such as 102a. The profile certification engine 214 may receive information pertinent to credentialing of each of the federated profiles associated with a common profile and then associate the defined weightages to each of the federated profiles and perform cumulative credentialing of the common profile. In an embodiment, the weightages may be determined based on parameters defined by a service provider who operates the system 108. In such embodiments, the weightages may be defined based on for example past experiences or current understanding about importance of accuracy of credentialing for different segments. For example, the accuracy of credentialing may be more important for work history than information pertinent to hobbies of a professional when applying for a job. Therefore, the objective use of the credentialing information may influence determination of the weightages and hence the overall credentialing. Therefore, a score indicative of the influence of the objective may be associated for the credentialing purposes in some embodiments. In some embodiments, the weightages may be defined by an agency such as 110 desiring the credentialing. Therefore, in such cases, the profile certification engine 214 may perform credentialing of the common profile in a custom define manner and also in association with the objective score.

The profile certification server 204 further includes the segment rating engine 208. The segment rating engine 208 is configured to associate a rating to each of the credentialed federated profiles based on credentialing from the crowdsourced plurality of respondents 104 and depending on a level of accuracy and trust associated with the credentialing of the federated profiles. The rating may depend on who credentialed a federated profile, when was a profile credentialed, how many times a profile was credentialed, how many unique credentials are done, relevance of respondents 104 credentialing the federated profile, relationship of the respondents 104 with the professional such as 102a of the credentialed federated profile, and the like.

The profile certification server 204 may further include the profile rating engine 210. The profile rating engine 210 is configured to associate a rating to an entire profile based on credentialing of each of the federated profiles and ratings associated with each of the federated profiles as determined by the segment rating engine 208 cumulatively.

The profile management server 202 is coupled to the profiles database 118 to store information pertinent to the profiles of the plurality of professionals 102. The profiles database 118 may be coupled to the federated profile manager 112 such that the federated profile manager 112 maintains the information stored in the profiles database 118.

The profile certification server 204 may be coupled to the profiles certification database 120. The profiles certification database 120 is configured to store information pertinent to credentialing such as certification status of the federated or common profiles associated with the plurality of professionals 102. For example, the certification status may include one or more of verified segment, verified profile, pending verification, verification in progress, segment rejected as incorrect, profile rejected as incorrect and the like. The profiles certification database 120 may be coupled to the profiles database 118 and the certification engine 116.

The profile certification server 204 may be coupled to the certified profiles database 216. The certified profiles database 216 may further be coupled the profiles certification database 120. The certified profiles database 216 may be configured to store profiles that have been verified by the certification engine 116. A medical entity or any other agency or entity such as the agency 110 may be allowed a direct access to the certified credential database 216 based on preferences and rules defined for the medical entity or the agency 110. The medical entity 110 may be one of a hospital, nursing center, doctor, physician, healthcare unit, and government healthcare department or any other third party or agency. The certified credential database 216 may further store information pertinent to one or more of work history, education, and personal demographics, affiliations to hospitals or other institutes etc of one or more professionals 102 corresponding to one or more of verified profiles.

The profiles database 118, profiles certification database 120, and the certified profiles database 216 may be coupled to a profiles sources database 218. The profile sources database 218 may include information about a plurality of sources in the crowdsourced network 106 that are linked to the federated profiles associated with the plurality of the professionals 102, and information about a plurality of sources who responds to the federated profiles for credentialing. For example, in the crowdsourced network 106, the plurality of respondents 104 may credential the federated profiles and thus the profiles sources database 218 may store their details, their names, other information, their relevance and relationship with the professionals 102 associated with the federated profiles they credential and time of credentialing, and location of original credentialing or any other such information pertinent to the credentialing sources etc.

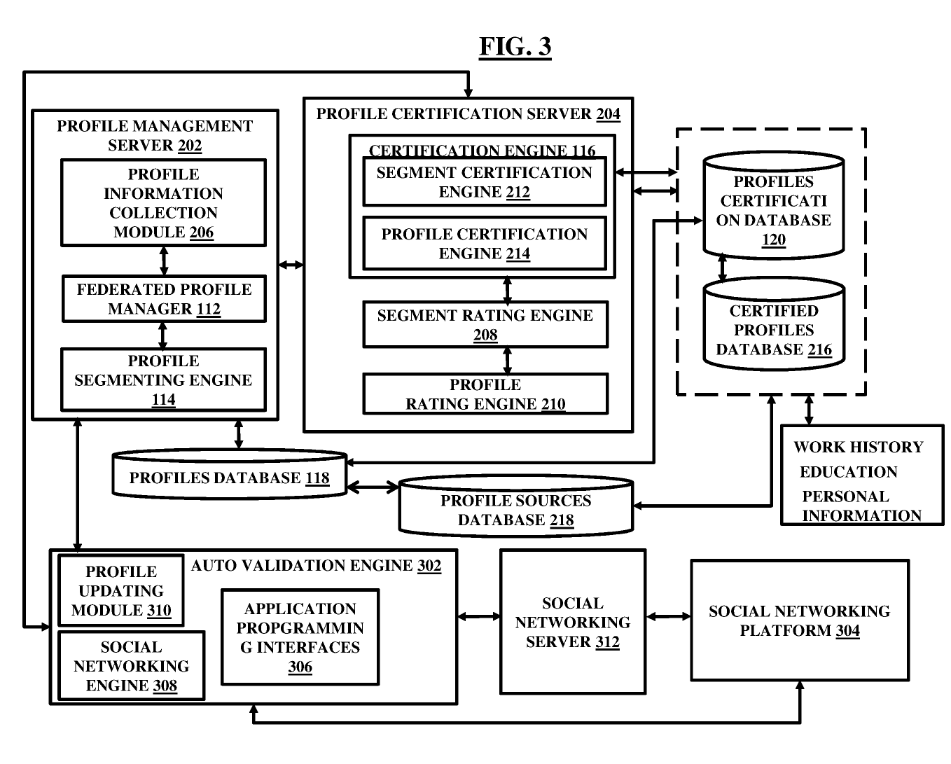

FIG. 3, with reference to FIGS. 1 and 2, illustrates another embodiment of the credentialing system 108. The credentialing system 108 may include the profile management server 202 and the profile certification server 204 as discussed above. The system 108 may further include an auto-validation engine 302 coupled to the profile certification server 204 and the profile management server 202. The auto-validation engine 302 is further communicatively linked to a social networking platform 304. The social network platform 304 hosts information related to one or more of the professionals 102. For example, the social networking platform 304 may host social profiles of the professionals 102 where the professionals 102 may store and update their personal, professional or other such details or may communicate in a social network with friends, relatives, family members, or other such networking contacts.

The auto-validation engine 302 is configured to further certify the credentialing of the federated profiles that is performed by the certification engine 116. The second level certification by the auto-validation engine 304 is performed by using the information about the one or more professionals 102 from the social networking platform 304. For example, a professional such as 102a may be associated with a social networking website such as a Linkedin or Facebook. The professional 102a may maintain a separate profile for each such social networking website. The credentialing of the professional 102a for specific federated profiles may thus be further verified by using the information obtained from the social networking profiles.

In an embodiment, the credentialing by the respondents 104 is used to associate a rating and define a level of trust for the federated profiles and the common profiles. The further verification based on the information obtained from the social profiles of the professionals 102 may further associate another rating or score to the federated profiles such that a level of trust about the plurality of professionals 102 and their federated and common profiles may be determined based on a cumulative effect of credentialing and the auto validation of the federated profiles and the common profiles. The cumulative score determined based on individual scores from the auto validation and the credentialing by the respondents 104 may define a net rating and overall credentialing of the federated profiles and the common profiles. The federated profiles and the common profiles in association with the information pertinent to the credentialing and the auto-validation may thus be used or accessed by the agencies 110 or medical entities such as hospitals or other similar agencies or medical entities to determine a level of trust in the credentialed information; i.e., the credentialed federated and thus common profiles.

The auto-validation engine 302 may include application programming interfaces (APIs) 306, a social networking engine 308, and a profile updating module 310.

The social networking engine 308 is coupled to one or more social networking server 312. The social networking engine 308, which may be controlled by the social network server 312, is configured to process a request of the system 108 for retrieving social profiles information and verifying the credentialed federated and common profiles by using the information obtained from the social profiles. The social networking engine 308 is communicatively coupled to the social networking platform 304 through the social network server 312 to allow interfacing of the system 108 with the social networking service or platform 304. The social network server 312 may provide a programmatic web interface via the network 106 for accessing the social profiles by the system 108. In some embodiments, the social networking server 312 may store social data related to the one or more professionals 102 obtained from the social profiles hosted by the social networking platform 304 to integrate the social data with the credentialed federated profiles for further verification or updating of the credentialing by auto-validation.

The social networking engine 308 may utilize the APIs 306 etc to allow verification of the federated segments associated with the plurality of professionals 102 based on the information contained in the social profiles of each of the professionals 102 maintained by the social networking platform 304. In an embodiment, the social profiles maintained by the social networking platform 304 are distinct from the federated or common profiles of the professionals 102 maintained by the federated profile manager 112. The APIs 306 further allow the auto-validation to determine an extent of mapping between the information contained in the two distinct profiles maintained by the federated profile manager 112 and the social networking platform 304. The social networking platform 304 may include several social networking sources. The social networking sources may include without limitations social networking websites, educational institutions, employers' databases etc. For example, a professional such as 102a may be associated with one or more of such or other similar social networking sources in the social networking platform 304. The APIs 306 are adapted to link each of the federated profiles to one or more such distinct sources of the social networking platform 304 such that a unique identifier is maintained that associate a distinct source of the social networking platform 304 to a federated profile.

The profile updating module 310 is configured to update or modify the profiles based on further verification of the federated profiles after auto-validation. For example even after the credentialing by the respondents 104, the auto-validation may demand to modify the federated profiles which the profiles updating module 310 may do, in some cases after seeking permissions from the professionals 102. The profile updating module 310 may be communicatively coupled to the profile management server 202 so as the federated profile manager 112 to store and maintain the modified federated and common profiles.

The social networking platform 304 may include for example one or more social networking sources. The sources may be such as social networking websites, educational institutions, employers' databases or portals or platforms, hiring agencies' portals, and other such sources of creating a socially aware network. Some examples of social networking websites are without limitations Linkedin, MySpace, About Me, etc.

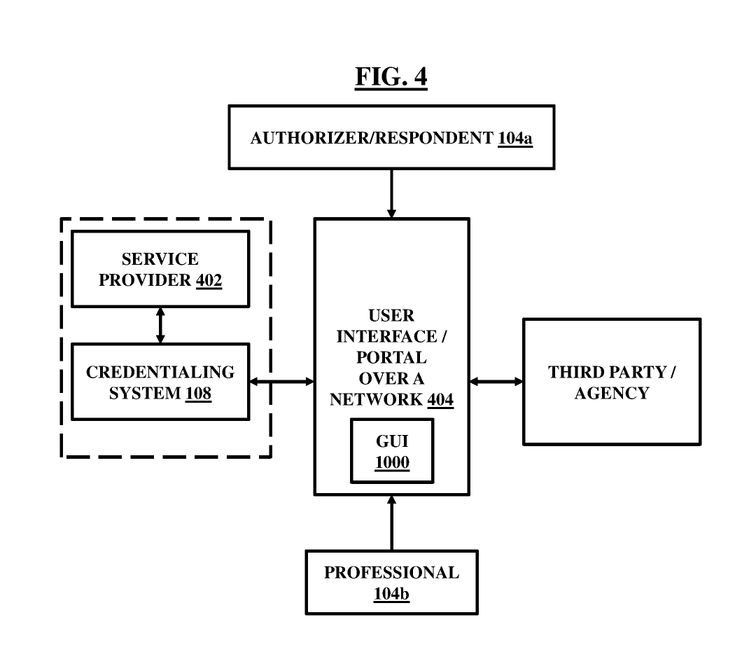

FIG. 4, with reference to FIGS. 1 through 3, illustrates an exemplary architecture including a service provider 402 which deploys the system 108 and provides credentialing services to the agencies 110. The agency 110 can be a hiring agency, recruitment and selection or placement department or agency, a medical entity such as a hospital or a medical institute etc. A professional such as 102a may submit his profile details to the service provider 402 that may be stored in the system 108. The service provider 402 may obtain verifications and credentialing of the profile details or other information provided by the professional 102a and may store the information pertinent to the credentialing of the information of the professional 102a. The service provider 402 may utilize a crowdsourced network 106 of people including such as the respondent 104a or authorizer 104a who may be any other professional or any of the respondents 104. The service provider 402, professional 102a and the respondent or authorizer 104a may connect with one another over the network 106 through a web-based graphical user interface 404 that may serve as a portal for interconnection. A GUI icon 1000 resides (e.g., is stored) on the GUI interface 404 and provides the mechanism for accessing the system 108. The portal or interface 404 may provide a subscription section through which the entities such as the professional 102a, agency 110, or the respondent/authorizer 104a may associate them with the system 108. Different sections may be provided for each to the professional 102a, respondent 104a, agency 110. Upon subscription, the professional 102a may be allowed to submit his details to the system 108 and/or create a profile.

The profile information may be publicly visible in some embodiments or may be made visible to the specific respondent 104a by the service provider 402 for credentialing purposes and receiving responses from the respondent 104a about the professional 102a. The profile information may be credentialed and verified in entirety or in segments as discussed above and may be stored in the system 108. The agency 110 may thus know accreditation or credentialing about the professional 102a by visiting the portal 404 through a separate section defined for such agencies 110. Therefore, through the web-based portal or interface 404, the agency 110 may be facilitated to collect credentialing information and the authenticity about the professional's profiles and other information by visiting the single centralized system 108 and may not need to verify the details of the profiles from several sources such as workplaces, educational institutes etc. Further, since the system 108 performs credentialing from a crowdsourced network of professionals 102, therefore, the accuracy of the credentialing and authenticity and reliability of the profiles' information may be higher and the agency can rely on the information with a greater degree of trust and reliability. Further, since the profile information is segmented into the federated profiles, therefore, the credentialing may be more specific to each of the information details contained in the federated profiles and the agency 110 may easily know which information is verified and which is not or which may be pending for verification. In some embodiments, the hiring agency may also know who verified a particular federated profile, when was a particular federated profile verified, and how many unique verifications are done for a specific federated profile. Therefore, with all these features provided through the present system 108, the credentialing may be made easier, quicker, trustable, reliable, accurate, and manageable. FIG. 4 depicts only one respondent 102a and one professional 102a for simplicity of the description, however the plurality of professionals 102 and respondents 104 may be connected with the system as discussed above in conjunction with previous figures.

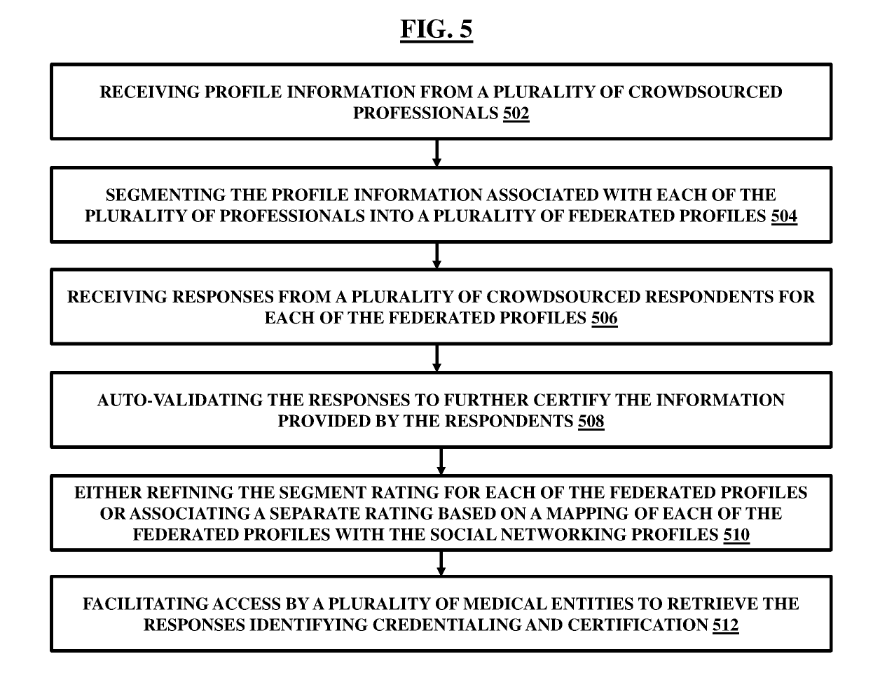

FIG. 5, with reference to FIGS. 1 through 4, illustrates a flow chart for a method for facilitating crowdsourced and multi-level credentialing over the network for use of multi-level credentialed information by the plurality of agencies 110 such as medical entities through the crowdsourced network 106. The method may include receiving the profile information from the plurality of crowdsourced professionals 102 at step 502. The information may include demographic, personal, educational, work history related or other types of details. The method may also include collating the information and creating a common profile specific for each of the professionals 102. In other embodiments, the submission of the information by the professionals 102 may be performed in an automated and defined way through the web interface 404 such that a profile is automatically created upon submission of the information and/or subscription with the system 108. The method may further include segmenting the common profile associated with each of the plurality of professionals 102 into a plurality of federated profiles at step 504, such that one set of federated profiles is created from a common profile associated with a professional such as 102a. Therefore, two types of profiles—a common profile, and federated profiles are maintained by the system 108. The method may further include allowing the federated profiles to be made available in public such that the federated profiles may be viewed by the crowdsourced plurality of respondents 104 or other professionals 102. The method may further include receiving responses from the plurality of crowdsourced respondents 104 or professionals 102 for the federated profiles at step 506. The responses may define credentialing of the federated profiles. For example, the system 108 may allow the respondents 104 to credential the information contained in the federated profiles. The more times the verifications or credentialing done by the respondents 104, the more accurate and reliable the credentialing of the federated profiles is.

The responses may define certification or credentialing of information contained in the federated profiles and the common profiles. The credentialing may be associated with each of the federated profiles individually and may conclude in either verified as correct or verified as wrong. Further, the crowdsourced credentialing facilitates the certification of each of the federated profiles by one or more respondents 104 so as to cumulate an effect of the certification at multiple levels defined by each respondent. For example, the certification may be done at a first level when a first respondent such as 104a certifies a particular federated profile. The second level certification may be done when another new respondent 104b credentials or verifies the same federated profiles. Similarly, multi-level certification, or credentialing may be performed. The cumulated effect of the certification allows to associate a cumulative segment rating or cumulative federated profile rating to each of the federated profiles associated with each of the professionals 102. The responses associated with each of the federated profiles are associated with attributes defining the source and the respondent certifying the federated profiles, and a date of certification by the respondent. It must be appreciated that the terms certification, verification, and credentialing are interchangeably used in the document without any limitations. The method may further include associating a rating to the federated and common profiles after credentialing of the profiles by the respondents 104. The method and system allows the multi-level credentialing by executing the crowdsourced credentialing process and also by performing credentialing of the federated profiles as well as the common profiles.

In some embodiments, the method may further include auto-validating the response or the credentialing done by the plurality of respondents 104 to further certify the information provided by the respondents 104 for each of the federated profiles at step 508. The auto-validation can be performed through one or more sources of the social networking platform 304 that associates a professional such as 102a through a social networking profile of the professional 102a. The method may further include either refining the federated profile rating for each of the federated profiles or associating a separate rating based on a mapping of each of the federated profiles with the social networking profile at step 510. The method may further include facilitating an access by the plurality of medical entities or other agencies 110 to retrieve the responses identifying credentialing and certification and the refined or associated rating through the web-based portal operating in the crowdsourced network at step 512. The agencies 110 may thus retrieve credentialed information from the service provider 402 through the system 108 and may not need to individually verify the information about a professional from several sources.

In some embodiments, the method of auto-validating may include automatically searching from a social networking database associated with the social networking sources to verify information about each of the federated profiles. In response to detection of a mismatch between the searched information and the federated profile, the method may further include suggesting a federated profile update. The method may further include suggesting the social networking profile update to the social networking platform 304. In this manner the service provider 402 may find an opportunity to collaborate with the social networking sources and may continually exchange any update on information from one another such that a credentialing process may flow either sides from both the service provider and the social networking sources.

In some embodiments, the respondents may include one or more of profile owners and other professionals or other persons.

In some embodiments, the method may include using the plurality of application programming interfaces (APIs) 306 to allow verification of information associated with each of the federated profiles of the plurality of professionals 102 from the social profiles of the professionals 102 maintained by the social networking platform 304. The APIs 306 may be adapted to link each of the federated profiles to one or more distinct sources of the social networking platform 304 such that a unique identifier is maintained that associate a distinct source of the social networking platform 304 to the respective federated profile.

In accordance with an embodiment herein, the system 108 may be configured to perform social crowdsourced credentialing of certified professionals 102.

In accordance with an embodiment herein, doctors, nurses, or other healthcare practitioners or other professionals may be accredited or credentialed by the system 108 as required before working in hospitals or other practice locations.

In accordance with an embodiment herein, the system 108 is configured to create the federated profiles and/or federated credentialing databases that may allow multiple parties such as respondents 104 to crowdsource and socially credential the professionals 102.

In accordance with an embodiment herein, the system 108 may be configured to facilitate disintermediating of credentialing services by for example allowing practices, hospitals, etc. to share each others' credentialing through the social, crowdsourced approach. The system 108 can allow creation of the profiles by the professionals 102 such as physicians and nurses etc. that various parties can share directly, and update directly.

The system 108 is configured to provide a capability or a federation model that may facilitate creating of profiles. These profiles can be exchanged and credentialing information may also be exchanged between various agencies or other parties. In an embodiment, the credentialing system may allow credentialing to be performed amongst specific agencies so that for example if hospital A (first agency or respondent) trusts hospital B (second agency or respondent), and the first agency credential a first part of the profile of a professional and the second agency credential a second part of the profile, then both these agencies may together create a more accurate profile with the use of the system 108 than created independently by sharing the credentialing information known to them individually in the form of responses to the originally created profile. The original profile that is created by the professionals 102 serves as the common profile. The profile may then be segmented into federated profiles such that each of the agencies 110 may credential at least one of the federated profiles. Upon thus credentialing, the agencies 110 may share the credentialed federated profiles such that an overall and more accurate accreditation of the originally created profile may be performed by the system 108. The system 108 may also consider the trust factor among the various credentialing parties or agencies 110 or respondents 104. For example, in the example above the first agency may identify that the second agency is a trusted source and therefore any profile credentialed by the second agency may be acceptable by the first agency. Therefore, the agencies 110 amongst themselves can together collaboratively perform credentialing and accreditation by deploying the system 108 internally, in some embodiments, without using a service from a third party service provider.

In an embodiment, the system 108 may allow the respondents 104 to disagree with one another. For example, a single federated profile may be credentialed by one respondent in one manner while the same profile may be credentialed by another respondent in another manner such that the way of credentialing by the second respondent may or may not be contradicting with the way the first respondent credential the same federated profile. Therefore, in such cases, the system 108 may allow to associate a degree of disagreement between the two or more credentialing patterns offered by the two or more respondents 104. The associated metrics or degrees or disagreement may be used by a professional such as 102a or any agency 110 to determine a level of trust for a particular credentialing with respect to a particular federated or a common profile of a professional such as 102a. The credentialing responses from both or more of such respondents 104 may be viewable in the system 108.

In accordance with an embodiment, the system 108 may allow a profile owner who may be a professional such as 102a to dispute the way credentialing is performed by the one or more respondents of 104 with respect to his federated or common profile. The profile owner who can be any one of the professionals 102 may offer his remarks through the system 108 which can be viewable by others. Based on such remarks by the profile owner, the system 108 may update, or modify or delete or retain as such the credentialing inputs from the respondents 104.

In accordance with an embodiment, the system 108 may allow software bots or internet bots to inject data from regular searches over the network 106. The bots may perform tasks such as searching and analysis of data from web sources.

In an embodiment, the system 108 may allow integration of a search engine capability within the system 108. The search engine may be used to populate findings from various information sources such as for example “Angie's list” <www.angieslist.com>, state agencies, legal searches or databases or any other similar information source.

In some embodiments, the system 108 may allow tracking of various federated and common profiles and classify them under different categories. For example, some of them may be tracked and classified as regulatory in nature for example a license; others may be tracked and classified as non-regulatory or any other class relevant for the purpose of classification. The classified profiles or items may further be tagged with the use of one or more tags. In some embodiments, several actions may be taken based on tagging of the items or profiles. For example, fraudulent or other items may be tracked using the tags associated with an item of a profile.

In accordance with some embodiments, the system 108 may be capable of implementing security and trust measures during data transfer such as during sharing of credentialing information among the respondents 104, or professionals 102 other than one to be credentialed or agencies 110. For example, in an embodiment, trust levels may be defined among the various agencies 110 and the credentialing may be associated with a respective trust level. For example, a first agency may trust a second agency and therefore any fragmented or common profile credentialed by the second agency can be acceptable to the first party. The first agency however may not trust an employee associated with the second agency, and therefore any profile credentialed by the employee at an individual level may not be acceptable to the first party. Therefore, the trust levels may be associated to accordingly identify relevance of the credentialing information. In an embodiment, credentialing information associated with one or more fragmented profiles can constitute a credentialed common profile only when the credentialing of each of the fragmented profiles constituted in the respective common profile are credentialed by agencies that hold a trust level relevant for consideration. In an otherwise scenario, in some embodiments, the credentialing without a desired trust level may be considered as non relevant and equivalent to as not credentialed or ignored. Therefore, the trust feature of the system 108 may facilitate to share credentialing information over the crowdsourced network by associating trust levels with respect to different credentialing agencies or respondents 104 or professionals 102.

In an embodiment, the system 108 may define trust features such that credentialing by a first agency trusted by a second agency would be trusted by a third agency that trusts the second agency. Similarly trust levels may be associated in an entire chain of trusting agencies, for example. In another embodiment, the system 108 may define trust features such that credentialing by a first agency trusted by a second agency would have to be reevaluated by a third agency before accepting the credentialing information even if the third agency trusts the second agency. In an embodiment, the different levels of trusts may be defined based on data type and nature of credentialing agencies or respondents or professionals or nature of the professionals to be credentialed and sensitivity of the credentialing information. In accordance with other embodiments, still several other types of trust-based security measurements may be implemented by the system 108 without limiting the spirit and scope of the embodiments herein.

In accordance with some embodiments, the system of the embodiments herein may facilitate rewarding of the respondents 104 who participate in credentialing and affiliation of the professionals 102. For example, in an embodiment, a reward system may be included in the credentialing system 108 such that the reward system may set parameters and rules for rewarding the respondents 104 and accordingly reward them based on the defined parameters and rules. The reward system may require enrolling of the respondents 104 for reward schemes. The reward system may increase the quality and efficiency of the credentialing and affiliation by the respondents 104. It may also encourage the use of high quality and cost effective credentialing. Further, the crowdsourced credentialing may be promoted by rewarding the respondents 104. This may also encourage interaction at large levels.

In some embodiments, the system 108 may define desirable standards for code of conduct by the crowdsourced respondents. In cases of breach of the standards by any of the respondents 104, the system may either invalidate enrollment of the respondents with the system 108 and/or may delete credentialing information provided by such a respondent and/or may issue a warning. In cases of subsequent breaches, the system 108 may permanently block the respondent from credentialing any of the professionals associated with the system 108. In an embodiment, the system 108 may therefore be configured to facilitate crowdsourced credentialing in association with the set standards of credentialing. The certification engine may allow the plurality of respondents 104 to respond to the federated profiles associated with the professionals 102 and credential them only when the set standards of conduct are met. In cases of breach of the standards, the certification engine may record details for the respondents and use it as an input in future processing of the credentialing by the same respondents.

In some embodiments, the system 108 may further facilitate tracking of professionals' code of conduct or their ethical breaches etc. For example, the system 108 may be configured to associate the profiles of the professionals 102 with information pertinent to the code of conduct, ethical lapses, past ethical behavior, recently known ethical lapses and other such information about the professionals 102. The information may be collected from various sources or may be reported by any other relevant or reliable professional or person or any member of the crowdsourced network 106 or any member subscribed with the system 108 and the like. Such ethical lapses may be updated in the fragmented and common profiles of the professionals 102. In some embodiments, the already credentialed profiles may also be changed or updated based on such ethical information. For example, credentialing information of a doctor as a professional who is credentialed through the system 108 by one or more respondents 104 or other professionals 102 may be invalidated upon finding of ethical lapses. In such cases, the profile may be directly updated so as to state the new ethical lapses in the profile or the profile may be considered as not credentialed at all, thus withdrawing prior credentials or the profile may be modified in any other manner so as to explicitly report the new lapses in the profile and update it accordingly.

In accordance with various embodiments, various components illustrated in conjunction with FIGS. 1-5 may include or be communicatively connected with memory circuits and processors to execute necessary programmed instructions.

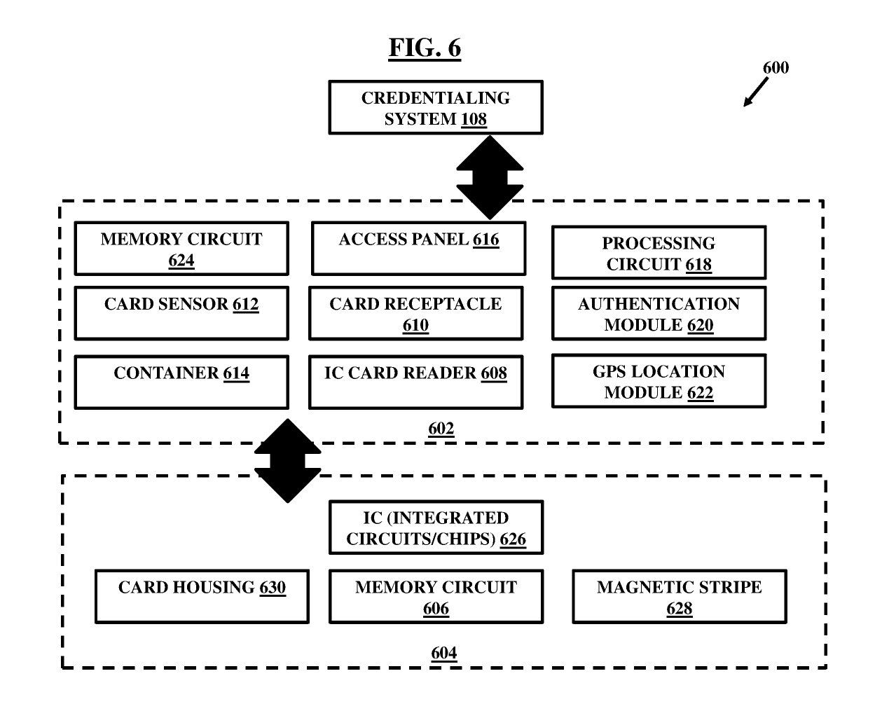

FIG. 6 illustrates a schematic diagram of a crowdsourced-credentialing-based smart controlled-access system 600. The crowdsourced-credentialing-based smart controlled-access system 600 may include the credentialing system 108 and various components thereof. The crowdsourced-credentialing-based smart controlled-access system 600 further includes a smart access card system 602 operatively and/or communicatively connected with the credentialing system 108. The smart access card system 602 may be issued to a subscriber (such as the third party/agency) who is registered with the credentialing system 108. The subscriber may for example be any of the agencies 110. The smart access card system 602 may be capable of reading smart access cards such as a smart access card 604. The smart access card 604 may be issued to a professional such as the professional 102a or any other professional. The smart access card 604 may store the common profiles or fragmented profiles or credentialing information about the professional 102a and identity information about the professional 102a in a memory circuit 606 of the smart access card 604.

The smart access card system 602 may include a card reader 608 (or IC card reader) configured to read the information stored on the smart access card 604. The smart access card system 602 may include a card receptacle 610 such that smart access card 604 may be inserted into the card receptacle 610 for reading of the information stored on the smart access card 604 by the card reader 608. The receptacle 610 of the smart access card system 602 is coupled to the card reader 608 to provide data enabling access to transmissions. In an embodiment, the receptacle 610 may be defined in the form of a rectangular slot. The smart access card system 602 may include a card sensor 612 to detect the presence of the smart access card 604 in the receptacle 610. The card sensor 612 may send this detected information to the card reader 608 for further processing. Various components of the smart access card system 602 including those shown in the FIG. 6 may be contained within a container 614 constructed of a metallic, non-metallic, plastic or any other material.

The smart access card system 602 may include an access panel 616 to display input and output details regarding a processing activity executed by a processing circuit 618 coupled to the card sensor 612, the card reader 608, an authentication module 620, and a GPS location module 622. The GPS location module 622 may detect GPS locations of the card reader 608 (or smart access card 604) and correlate it with permissible GPS locations according to predefined rules stored in a memory circuit 624 of the smart access card system 602. For example, in accordance with the predefined rules in an embodiment, the smart access card 604 may be activated only within the permissible GPS locations. If the smart access card 604 is read by the card reader 608 which is beyond the permissible GPS locations of the smart access card 604, the processing of the smart access card 604 may not be allowed by the processing circuit 618. The authentication module 620 may be configured within or connected to the processing circuit 618 to authenticate the permissible GPS locations during a transaction.

The smart access card 604 may include integrated circuits (IC) 626 and may be configured as an IC card. In an embodiment, the smart access card 604 may include a magnetic stripe 628 which when comes in contact with the receptacle 610 can be sensed by the sensor 612. Various components of the smart access card 604 such as shown in FIG. 6 may be housed in a card housing 630 manufactured of a metallic, non-metallic, plastic or any other material. The information stored on the smart access card 604 may be encrypted. The encrypted information may be read by the smart access card reader 608.

The smart access card system 602 may receive an input from a user when the card 604 is contacted to the reader 608 and determine if the input is valid. If the user input is valid, the card reader 608 may respond by enabling the magnetic stripe 628 contained within the card 604. The magnetic stripe 628 may be enabled for a limited time after which it may then be disabled. A disabled magnetic stripe 628 may then be inoperable for activating card readers 608. A card 604 which is lost or stolen cannot be used by unauthorized users as it may have a magnetic stripe 628 in a disabled state and only an authorized user would have the ability to enable it. The card 604 may possess a high level of compatibility with known methodology in the art and may not require additional equipment and systems to attain its high security level.

In addition to the primary elements mentioned above and illustrated in the FIG. 6, secondary elements such as a data store, comparator, pulse generator may be included in the smart access card system 602 and the smart access card 604. These elements are additional functions of a microprocessor. The container 614 and the housing 630 may provide a mechanical structure to these devices. A keypad may also be available for user inputs and may be in communication electronically with the processing circuit 618. Tactile input from a user may be converted to an electronic pulse or pulses and transmitted to the processing circuit 618.

In an embodiment, the smart access card system 602 may be communicatively and/or operatively connected to the credentialing system 108 such that the profile, credentialing and authentication information about the card bearer (whose profile may be stored in the credentialing system 108) stored in the profiles certification database 120, certified profiles database 216, profile management server 202, and the profile certification server 204 may be updated dynamically within the memory circuit 624 of the smart access card system 602. A third party/agency may deploy the smart access card system 602 so as to allow access to only verified, authenticated and credentialed profile bearers by comparing the dynamically updated information with the identity information of the card bearer when the card 604 comes in contact of the smart access card system 602 and a transaction is executed by the processing circuit 618 of the smart access card system 602. In accordance with an embodiment, the smart access card system 602 may be employed to execute such a transaction by the third party/agency to restrict access to physical spaces. In accordance with an embodiment, the smart access card system 602 may be employed to execute such a transaction by the third party/agency to restrict access to certain categories of health transactions permissible only to different degree of verified profiles. For example, in an embodiment, a particular health transaction such as recommending a health guideline for developing a government policy may require high degree of expertise, experience as a senior physician in a particular health category, certain medical qualifications, recommendations from others, and a superior trust score from others. This can be possible when the professional who is the card bearer and who holds a profile in the credentialing system 108 confirms his identity by performing the transaction physically so that the smart access card system 602 may match the identity information with the locally stored information in the smart access card system 602 as obtained from the credentialing system 108. If the transaction verifies the profile of the card bearer to be eligible to take an action (such as recommending a health guideline etc), the card bearer may use the encrypted card information to further perform the action which can be served to concerned third party/agency for submission and approvals etc.

In an embodiment, the smart access card system 602 may be employed to provide access to restricted areas such as buildings, stadiums and departments. It is especially suitable for use with facilities where access is restricted to only employees and key personnel only. Such applications require the features of personnel licensing and identification to be provided by the smart access card system 602. Such applications may require the features enabled through the GPS location module 622. In such an embodiment, the smart access card system 602 may provide access through GPS (Global Positioning System) location validation. For example, systems and methods disclosed herein can verify a user by identifying a GPS location of a user. When the location of the user is same as or within a predetermined distance from the permissible GPS locations, then systems and methods can determine that the user using the card is verified and can grant the requested access to that user.

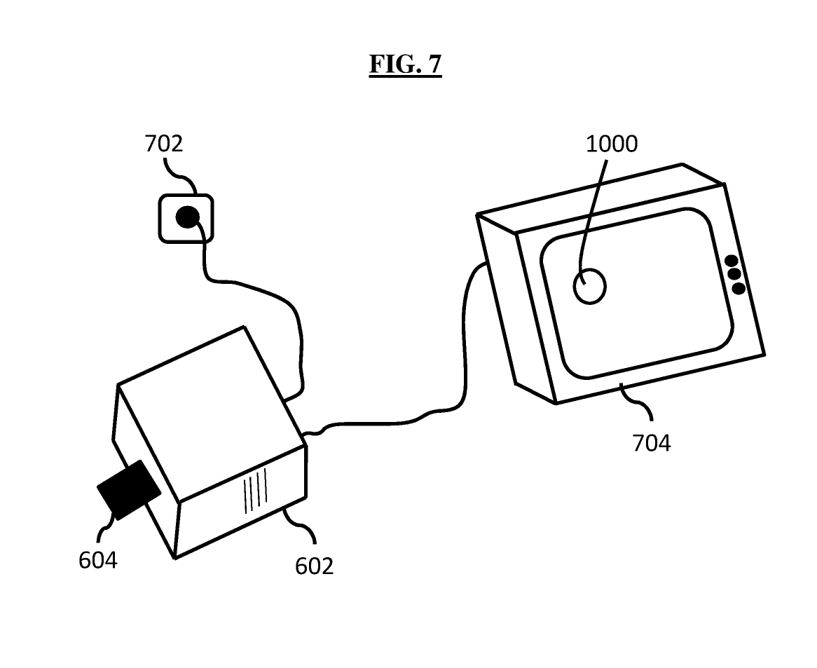

An exemplary perspective view of the smart access card system 602 along with the smart access card 604 is illustrated in FIG. 7. As shown in FIG. 7, the smart access card system 602 may operate using power 702 from direct supply. In an embodiment, the smart access card system 602 may include an inbuilt battery to provide power supply for operational activity. Various output details may be presented on a display device 704 (and accessible through a GUI 1000) such as the common profiles or the credentialing information associated with the common profiles etc.

In accordance with various embodiments, the smart access card 604 may be configured as a transaction card operable as a smart card, credit card, debit card, access card etc for authentication and proper user verification based on credentialing of the user profiles by the credentialing system 108 to ensure restricted access to specific actions and activities and/or premises as prescribed and defined by the third party/agency by deployment of the access system locally communicatively connected to the credentialing system 108. Individual smart access cards may be printed and distributed across users who are associated with the credentialing service so that the information stored on the server can be dynamically linked and updated, with identifier and access information stored on the access-controlled smart access card 604. The cards may be used to allow access to users with only reliable and trustworthy scores. A person may not get any access today but as credentialing scores, which will be dynamically updated on the server and the access system will also be dynamically updated for the updated scores, improve the same user may get access later. The access may be defined for special private locations which may need to be controlled for only reliable and authority persons and/or for particular actions executable through the smart access card 604.

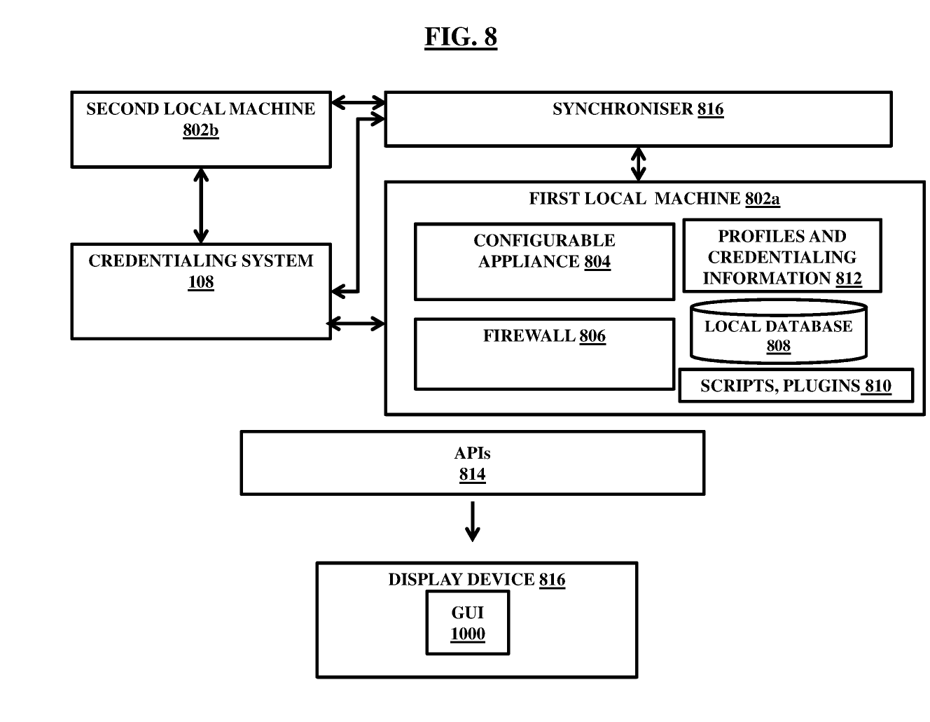

FIG. 8 illustrates a schematic diagram of the credentialing system 108 communicatively and/or operatively connected with a plurality of local machines such as a first local machine 802a and a second local machine 802b situated at distributed separate locations. The first local machine 802a may include a configurable appliance 804 which may be installed behind a firewall 806. The first local machine 802a may include a local database 808 which may store scripts, plugins etc 810. The database 808 may also store the common and fragmented profiles and credentialing information 812 in part obtained from the profiles database 118, profiles certification database 120, and the certified profiles database 216. The database 808 may also store a plurality of application programming interfaces (APIs) 814. The configurable appliance 804 may be defined in the form of a hardware structure with programmable devices therein so that the configurable appliance 804 can be installed behind the firewall 806 to perform necessary tasks. The first local machine 802a can be contained within a housing structure containing all the illustrated components. A display device 816 comprising GUI 1000 may facilitate presentation of an output to a user in response to a user request such that the output may be indicative of the common profiles and respective credentialing information and overall trust factor stored on the local database after processing or any other information related to the professionals 102 and respondents 104.

In an embodiment, the configurable appliance 804 may receive information from various sources including such as from the credentialing system 108 and components thereof, various health information sources, and the like without limitations obtained from cloud. The information may be provided by the credentialing system 108, in an example, to the plurality of configurable appliances located at separate locations and the information can be synchronized across all the configurable appliances at the same time by a synchronizer 816. The synchronizer 816 may be connected communicatively with the credentialing system 108 and with each of the plurality of local machines. The configurable appliance 804 installed behind the firewall 806 facilitates access to the stored information and obtained from the credentialing system 108 in an entire network zone.

In an embodiment, the first local machine 802a may allow aggregation, retrieval, editing, refining, filtering and various other tasks in accordance with various embodiments.

In accordance with embodiments, each of the plurality of local machines may include hardware and software components similar to those illustrated in conjunction with the first local machine 802a.

In accordance with the embodiments discussed above, the first local machine 802a may be installed in a network zone of the third party/agency who may subscribe to the credentialing service. The third party/agency may receive the credentialing and profile information for the plurality of professionals associated with the credentialing system 108 directly from the cloud to the first local machine 802a installed within the network zone of the third party/agency. The retrieved information can then be locally stored on the database 808 which can then be accessed by users in the network zone. The synchronizer 816 may dynamically update the information on the database 808 in accordance with evolution and updates in the profiles of the professionals 102 over time. The credentialing system 108 can execute various tasks of sourcing, fragmenting, and credentialing of the profiles as discussed elsewhere in the document so that outputs generated by the credentialing system 108 are parsed to the configurable appliance 804 of the first local machine 802a using the synchronizer 816. While the embodiment is discussed in conjunction with the first local machine 802a and associated components thereof, various embodiments can involve use of one or more additional similar or different local machines without limitations. The information obtained from the cloud at the first local machine 802a may exist in different standard or non-standard formats. The configurable appliance 804 may be configured to standardize this data before it is accessed and used by users in the network zone. In an embodiment, the data obtained from the cloud may be fragmented and the configurable appliance 804 may first organize the data before it is used by the users. The configurable appliance 804 may also allow manual process of data merging in accordance with an embodiment of the present invention.

In accordance with an embodiment, the present invention provides a distributed credentialing platform through the credentialing system 108. The credentialing system 108 may issue digital certificates such as digital experience certificates, digital education certificates, digital workforce certificates, or digital professional certificates in the form of the smart access card 604 as discussed above. These digital certificates may be dynamically updated as a certificate holder's credentials improve or worsen over time. The data stored in the digital certificates can be shared publicly in the manner as discussed above with respect to use of the smart access card 604.

In an embodiment, organizations can maintain digital certificates for their employees that can contain a wide range of details about an employee's skills, achievements, or characteristics, and register it on the digital certificates. Anyone can connect with the credentialing system 108 and verify the certificate holder's information by visiting profile of the certificate holder through an interface to access the credentialing system 108. The certificate holder can be any professional such as the professionals 102.

In an example, the smart access card 602 or the digital certificates (used interchangeably without limitations) may be configured as digital wallets such that the digital wallets may not necessarily be physically contacted with a machine similar to the smart access card system 602, instead the digital wallets may be communicatively connected with the smart access card system 602 remotely and through a wired and/or a wireless network to execute necessary transactions.

The present invention provides an open secured platform for digital certificates and reputation management to create a verification infrastructure that allows to control full records of achievements, qualifications, experiences, reputations, and accomplishments and also allows to share the digital credentialing and profiles information with a third party/agency giving a complete trust that the profiles are in acceptable or unacceptable shape and that the credentials are issued to the professional.

The embodiments herein may be embodied as a computer program product configured to include a pre-configured set of instructions, which when performed, can result in actions as stated in conjunction with the methods described above. In an example, the pre-configured set of instructions can be stored on a tangible non-transitory computer readable medium or a program storage device. In an example, the tangible non-transitory computer readable medium can be configured to include the set of instructions, which when performed by a device, can cause the device to perform acts similar to the ones described here. Embodiments herein may also include tangible and/or non-transitory computer-readable storage media for carrying or having computer executable instructions or data structures stored thereon.

Generally, program modules include routines, programs, components, data structures, objects, and the functions inherent in the design of special-purpose processors, etc. that perform particular tasks or implement particular abstract data types. Computer executable instructions, associated data structures, and program modules represent examples of the program code means for executing steps of the methods disclosed herein. The particular sequence of such executable instructions or associated data structures represents examples of corresponding acts for implementing the functions described in such steps.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can include both hardware and software elements. The embodiments that are implemented in software include but are not limited to, firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

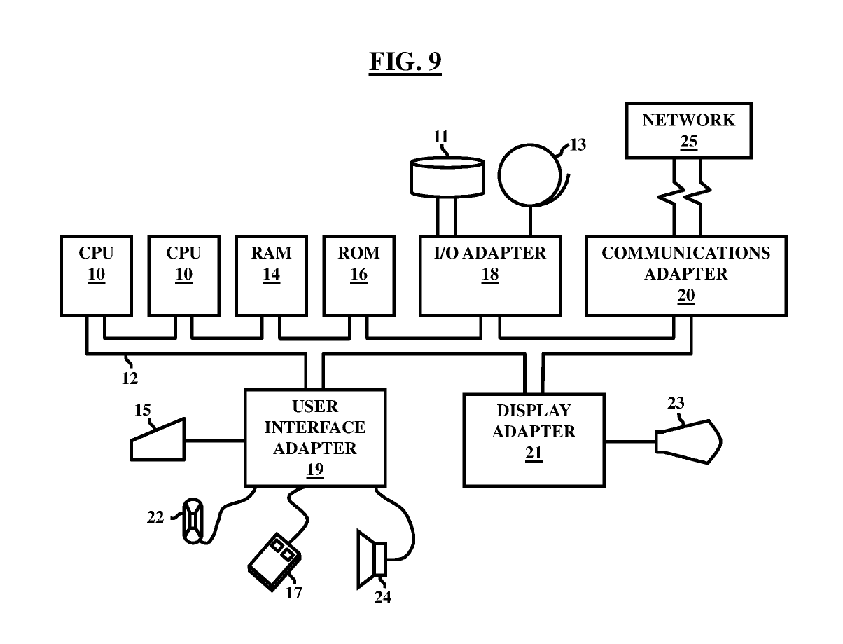

A representative hardware environment for practicing the embodiments herein is depicted in FIG. 9, with reference to FIGS. 1 through 8. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein. The system further includes a user interface adapter 19 that connects a keyboard 15, mouse 17, speaker 24, microphone 22, and/or other user interface devices such as a touch screen device (not shown) to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example, which provides a GUI 1000 in accordance with the embodiments herein.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A graphical user interface (GUI) accessed locally on a computer screen and configured to provide access to a distributed architecture-based system for facilitating crowdsourced credentialing over a crowdsourced communication network, said system comprising:
a GUI icon stored on a computerized display device;
a profile management server, communicatively connected to said crowdsourced communication network and accessible through said GUI icon, comprising:
a profile information collection module of said distributed architecture based system, comprising a collection processor and a collection memory, configured to collect profile creation information about each of a plurality of professionals distributed over said crowdsourced communication network, wherein said profile creation information is collected from:
said plurality of professionals distributed over said crowdsourced communication network; and
a plurality of online websites of said plurality of professionals, wherein an online website comprises a social networking profile associated with a social networking platform, and an institutional website, wherein said social networking profile is distinct from said institutional website;
a federated profile manager of said distributed architecture based system, communicatively coupled to said profile information collection module and comprising a profile manager processor and a profile manager memory, said federated profile manager is configured to:
create a plurality of common profiles corresponding to each of said plurality of professionals, using said collected profile creation information by said profile information collection module;
a profile segmenting engine of said distributed architecture based system, communicatively coupled to said federated profile manager and accessible through said GUI icon and comprising a profile segmenting processor and a profile segmenting memory, said profile segmenting engine configured to:
segment each of said plurality of common profiles into a plurality of portions;
communicate each of said plurality of portions to said federated profile manager, wherein said federated profile manager is further configured to store said plurality of portions;
a profiles database of said distributed architecture based system accessible through said GUI icon, and configured to centrally store said plurality of common profiles of said plurality of professionals on a first non-transitory storage media, wherein said profiles database is communicatively coupled to said profile management server, such that said federated profile manager maintains said plurality of common profiles stored in said profiles database;
a profile certification server accessible through said GUI icon and communicatively connected to said crowdsourced communication network, comprising:
a certification engine of said distributed architecture-based system configured to facilitate credentialing of said plurality of common profiles, said certification engine comprises:
a segment certification engine, comprising a segment certification processor and a segment certification memory, said segment certification engine configured to:
make available said plurality of portions of each of said plurality of common profiles for verification by a plurality of respondents;
receive a plurality of crowdsource responses from said plurality of respondents, using said crowdsourced communication network, wherein each of said plurality of crowdsource responses:
corresponds to one portion of said plurality of portions of each of said plurality of common profiles;
indicates said one portion as correct or as wrong; and
includes an attribute indicating a corresponding respondent for said one portion, and a date of said response;
credential said one portion, using said crowdsource response, wherein the credentialing said one portion is separate from credentialing any other portion in said plurality of portions;
determine a level of accuracy of said credentialing of said one portion using a number of crowdsource responses corresponding to said one portion; and
a profile certification engine comprising a profile certification processor and a profile certification memory, wherein said profile certification engine is configured to:
credential the entirety of a common profile that includes said one portion, using a first set of crowdsource responses, wherein all responses in said first set of crowdsource responses correspond to said common profile;
determine an index of inconsistencies of said common profile, using a distribution of differences across a plurality of responses corresponding to each portion in said common profile;
determine a distribution map indicating extent and coverage of said inconsistencies among said plurality of responses corresponding to each portion in said common profile;
determine an overall trust factor of said common profile using said index of inconsistencies and said distribution map; and
an auto-validation engine of said distributed architecture-based system accessible through said GUI icon, and comprising an auto-validation processor and an auto-validation memory, communicatively coupled to said profile management server and said profile certification server, and platforms hosting said online websites containing information related to said plurality of professionals, wherein said auto-validation engine is configured to certify said credentialing of said common profiles, already certified by said certification engine, by using said information about said professionals from said online websites,
wherein, through a plurality of distributed local machines, one or more of said common profiles and respective credentialing information are accessible by distributed medical entities for learning said overall trust factor about said plurality of common profiles of said plurality of professionals based on a cumulative effect of credentialing and said auto validation of said profile related information, wherein said plurality of local machines comprising at least a first local machine, the first local machine comprising:
a firewall located in a private network zone;
a configurable appliance installed behind said firewall to allow access to a set of computing devices within said network zone of said configurable appliance;
a local database communicatively and operatively connected with said configurable appliance for storing, at least in part, said common profiles and respective credentialing information and overall trust factor parsed by said credentialing system; and
the display device for presenting an output to a user in response to a user request, said output indicative of said common profiles and respective credentialing information and overall trust factor stored on said local database after processing.

2. The system of claim 1, wherein said auto-validation engine comprises a plurality of application programming interfaces (APIs) allowing verification of information associated with each of said plurality of common profiles of said plurality of professionals from respective said social profile of each of said professionals maintained by said social networking platform, wherein said social profile maintained by said social networking platform is distinct from said profiles of each of said professionals maintained by said federated profile manager, wherein said APIs further allow to determine an extent of mapping between said information contained in said two distinct profiles maintained by said federated profile manager and said social networking platform, and wherein said APIs are adapted to link each of said plurality of portions to one or more distinct sources of said social networking platform such that a unique identifier is maintained that associate a distinct source of said social networking platform to each of said plurality of portions.

3. A smart card reader system for accessing a crowdsourced-credentialing-based smart controlled-access system facilitated through crowdsourced credentialing over a crowdsourced communication network, said smart card reader system comprising:
a profile management server, communicatively connected to said crowdsourced communication network, comprising:
a profile information collection module comprising a collection processor and a collection memory, configured to collect profile creation information about each of a plurality of professionals distributed over said crowdsourced communication network, wherein said profile creation information is collected from:
said plurality of professionals distributed over said crowdsourced communication network; and
a plurality of online websites of said plurality of professionals, wherein an online website comprises a social networking profile, and an institutional website, wherein said social networking profile is distinct from said institutional website;
a federated profile manager communicatively coupled to said profile information collection module, said federated profile manager is configured to:
create a plurality of common profiles corresponding to each of said plurality of professionals, using said collected profile creation information by said profile information collection module;
a profile segmenting engine communicatively coupled to said federated profile manager and comprising a profile segmenting processor and a profile segmenting memory, said profile segmenting engine configured to:
segment each of said plurality of common profiles into a plurality of portions; and
communicate each of said plurality of portions to said federated profile manager, wherein said federated profile manager is further configured to store said plurality of portions;
a profiles database configured to centrally store said plurality of common profiles of said plurality of professionals on a first non-transitory storage media, wherein said profiles database is communicatively coupled to said profile management server, such that said federated profile manager maintains said plurality of common profiles stored in said profiles database;
a profile certification server, communicatively connected to said crowdsourced communication network, comprising:
a certification engine of said distributed architecture-based system configured to facilitate credentialing of said plurality of common profiles, said segment certification engine comprises:
a segment certification engine, comprising a segment certification processor and a segment certification memory, said segment certification engine configured to:
make available said plurality of portions of each of said plurality of common profiles for verification by a plurality of respondents;
receive a plurality of crowdsource responses from said plurality of respondents, using said crowdsourced communication network, wherein each of said plurality of crowdsource responses:
corresponds to one portion of said plurality of portions of each of said plurality of common profiles;
indicates said one portion as correct or as wrong; and
includes an attribute indicating a corresponding respondent for said one portion, and a date of said response;
credential said one portion, using said crowdsource response, wherein said credentialing of said one portion is separate from credentialing any other portion in said plurality of portions;
determine a level of accuracy of said credentialing of said one portion using a number of crowdsource responses corresponding to said one portion; and
a profile certification engine comprising a profile certification processor and a profile certification memory, wherein said profile certification engine is configured to:
credential said entirety of a common profile that includes said one portion, using a first set of crowdsource responses, wherein all responses in said first set of crowdsource responses correspond to said common profile;
determine an index of inconsistencies of said common profile, using a distribution of differences across a plurality of responses corresponding to each portion in said common profile;
determine a distribution map indicating extent and coverage of said inconsistencies among said plurality of responses corresponding to each portion in said common profile;
determine an overall trust factor of said common profile using said index of inconsistencies and said distribution map;
wherein one or more of said common profiles are accessible by medical entities for learning said overall trust factor about said plurality of common profiles of said plurality of professionals based on credentialing of said profile related information; and
a smart access card system comprising:
a memory circuit to store predefined rules and said common profiles and respective credentialing information and overall trust factor for processing authentication and providing a controlled access to a smart access card;
an integrated circuit (IC) card reader to read information stored on said smart access card;
a card receptacle such that said smart access card is configured to be inserted into said card receptacle for reading of said information stored on said smart access card by said IC card reader;
a card sensor to detect presence of said smart access card in said receptacle such that said detected information is passed to said IC card reader for further processing;
a processing circuit to process said information read by said IC card reader and provide controlled access to said smart access card based on said predefined rules stored in said memory circuit;
an access panel to display input and output details regarding a processing activity executed by said processing circuit; and
a container to house components of said smart access card system structurally.

4. The system of claim 3, further comprising a network interface to facilitate communication between said smart access card system and said credentialing system over said crowdsourced network.

5. The system of claim 3, further comprising an authentication module communicatively and operatively coupled to said processing circuit for executing instructions to authenticate identification details of said smart access card.

6. The system of claim 5, wherein said smart access card comprising a magnetic stripe which when comes in contact with said receptacle of said smart access card system is sensed by said sensor to execute said instructions for authentication of said details stored on said smart access card.
